(19) United States
(12) Patent Application Publication
(10) Pub. No.: US 2009/0265573 A1
(43) Pub. Date: Oct. 22, 2009

(54) DATA TRANSMISSION/RECEPTION CIRCUIT

(75) Inventor: Hirohisa Tanabe, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/410,792

(22) Filed: Mar. 25, 2009

(30) Foreign Application Priority Data
Apr. 22, 2008 (JP) 2008-111243

(51) Int. Cl. G06F 1/04

(52) U.S. Cl. 713/502

(57) ABSTRACT

The present invention provides a data transmission/reception circuit which stops the operation of a packet transmission/reception circuit during a data transfer-free time thereby to realize power savings. The data transmission/reception circuit includes a packet transmission/reception circuit for performing transmission/reception of data to and from an external USB host via a USB bus at one data transfer intervals per predetermined frame, a clock generator for generating a clock signal and supplying the clock signal to the packet transmission/reception circuit, and a clock gating signal generating circuit for stopping the supply of the clock signal to the packet transmission/reception circuit by the clock generator during a frame free of the transmission/reception of the data by the packet transmission/reception circuit.

### BACKGROUND OF THE INVENTION

The present invention relates to a data transmission/reception circuit, and particularly to a data transmission/reception circuit provided on the side of a USB device where the transfer of data in a periodic transfer mode is executed between a USB (Universal Serial Bus) host and the USB device.

In recent years, a USB-spec data transmission/reception device has been frequently used as a standard interface of a computer. As the periodic transfer of data by a USB bus in such a data transmission/reception device, a data transfer is executed via a USB bus 30 between a USB host 10 and a SUB device 20 such as shown in FIG. 5 for every predetermined time with a time interval called “frame 11” as the reference, as shown in FIG. 4.

The USB host 10 transmits an SOF (Start of Frame) packet 12 indicative of the start of the frame 11 for every time of one frame and a data transfer (including a token packet and transmitted or received data packet) set at every predetermined interval (3 in the example of FIG. 4) to the USB device 20.

When an idle state absolutely free of occurrence of the transfer of each packet continues for over 3 ms on the USB bus 30, it is determined that the USB device 20 is in a suspend state. Hence, a clock generator 29 lying within the USB device 20 is deactivated so that power savings is realized.

As a technique for realizing power savings by such a method, there has been proposed a transmission control device (refer to, for example, a patent document 1 (Japanese Unexamined Patent Publication No. 2000-183894)) which stops oscillations of a transmission clock #1 (fast clock) during a suspend period and supplies a clock #2 (slow clock) only to an event monitoring device for monitoring the occurrence of an event.

However, the circuit having the configuration of FIG. 5 and the transmission control device of the patent document 1 are respectively accompanied by a problem that during a time 14 (refer to FIG. 4) indicative of “no data transfer”, a packet transmission/reception circuit that needs not to operate during this time is in an operating state, thereby consuming needless power.

### SUMMARY OF THE INVENTION

The present invention has been made to solve the above problem. It is an object of the present invention to provide a data transmission/reception circuit which stops the operation of a packet transmission/reception circuit during a data transfer-free time thereby to realize power savings.

According to the invention of a first aspect, for attaining the above object, there is provided a data transmission/reception circuit comprising transmission/reception means for performing transmission/reception of data to and from an external host device via a bus at one data transfer intervals per predetermined number of frames, clock signal generating means for generating a clock signal and supplying the clock signal to the transmission/reception means, and clock signal stopping means for stopping the supply of the clock signal to the transmission/reception means by the clock signal generating means during a frame free of the transmission/reception of the data by the transmission/reception means.

According to the invention of the first aspect, the operation of the transmission/reception means is stopped during the period free of transmission/reception of the data by the transmission/reception means, thereby making it possible to implement power savings.

A data transmission/reception circuit according to a second aspect is provided wherein in the data transmission/reception circuit according to the first aspect, after the transmission or reception of the data, the clock signal stopping means stops the supply of the clock signal from the completion of reception of a frame start packet transmitted from the host device by the transmission/reception means to a time prescribed based on the speed of the data transfer and the data transfer interval.

According to the invention of the second aspect, the time free of transmission/reception of the data by the transmission/reception means can be determined accurately.

A data transmission/reception circuit according to a third aspect is provided wherein in the data transmission/reception circuit according to the first or second aspect, bus state value observing means for detecting a change of the speed of the data transfer by the bus and a resume signal for the supply of the clock signal is further provided, and when the change of the speed of the data transfer by the bus or the resume signal for the supply of the clock signal is detected by the bus state value observing means, the clock signal stopping means starts the supply of the clock signal to the transmission/reception means.

According to the invention of the third aspect, the supply of the clock signal can be resumed as needed while the supply of the clock signal to the transmission/reception means is being stopped.

According to the present invention as described above, there is obtained an advantageous effect in that the operation of a packet transmission/reception circuit is stopped during a data transfer-free time, thereby making it possible to implement power savings.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a schematic configuration diagram of a data transmission/reception circuit according to an embodiment of the present invention;

FIG. 2 is a time chart showing the operation of the data transmission/reception circuit according to the embodiment of the present invention;

FIG. 3 is a diagram illustrating a configuration example of a clock gating signal generating circuit according to the embodiment of the present invention;

FIG. 4 is a time chart showing the operation of a data transmission/reception circuit according to a related art; and

FIG. 5 is a schematic configuration diagram of the data transmission/reception circuit according to the related art.

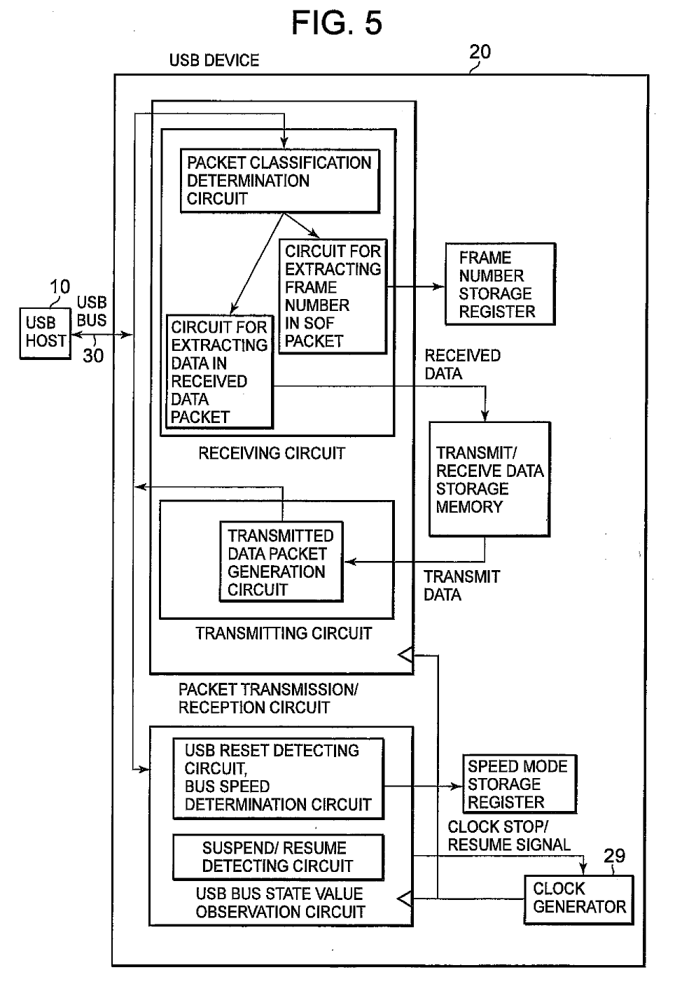

### DETAILED DESCRIPTION OF THE PREFERRED EMBODIMENTS

A preferred embodiment of the present invention will hereinafter be described with reference to the accompanying drawings.

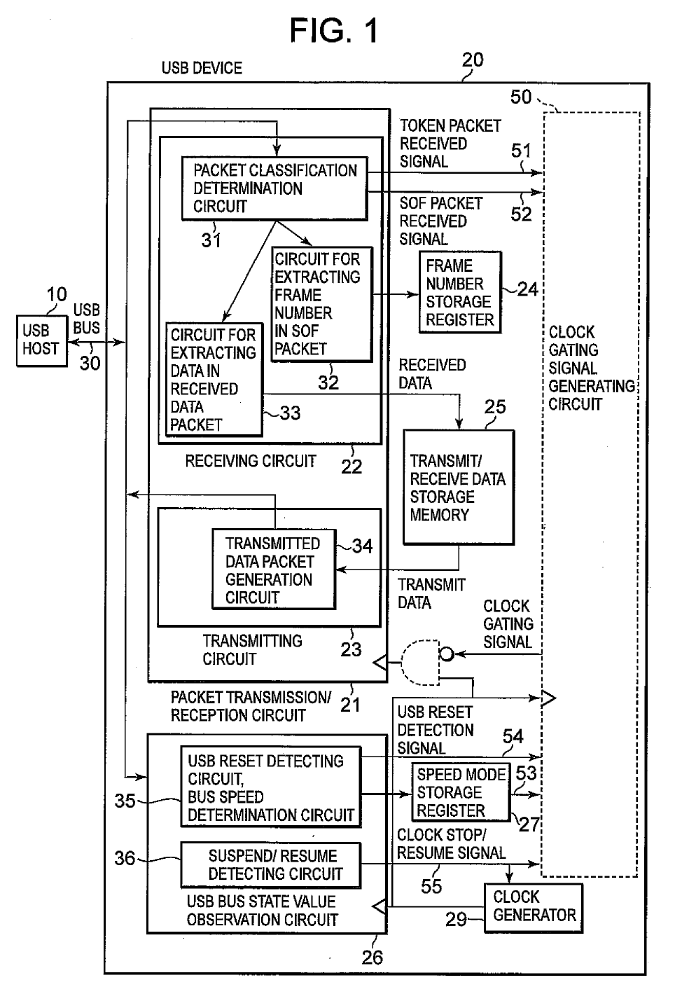

FIG. 1 is a schematic configuration diagram of a data transmission/reception circuit according to a preferred embodiment of the present invention. As shown in the same figure, the data transmission/reception circuit provided in a USB device 20 performs the transfer of data to and from a USB host 10 via a USB bus 30. The data transmission/reception circuit has a packet transmission/reception circuit 21 including a receiving circuit 22 and a transmitting circuit 23, a frame number storage register 24, a transmit/receive data storage memory 25, a USB bus state value observation circuit 26, a speed mode storage register 27, a clock generator 29 and a clock gating signal generating circuit 50.

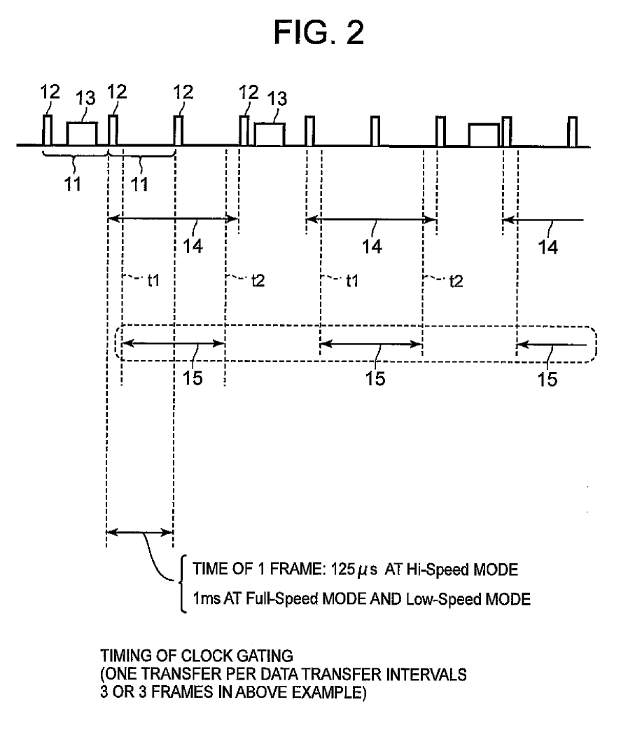

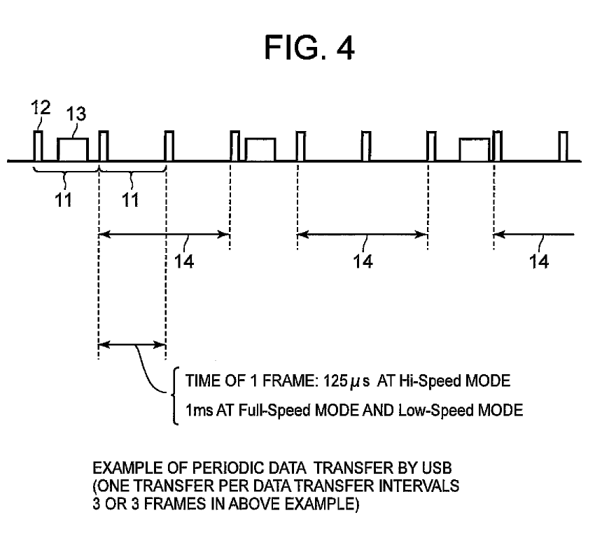

As the transfer of periodic data by the USB bus 30 in the data transmission/reception circuit configured;in this way, data transfer is performed between the USB host 10 and the USB device 20 for every predetermined time in the same manner as the related art (refer to FIG. 4) with a time interval called “frame 11” as the reference as shown in FIG. 2.

In order to configure the frame 11, the USB host 10 generates an SOF packet 12 for every time of 1 frame and transmits it to the USB device 20. In the USB device 20, a packet classification determination circuit 31 determines a packet classification as to whether a received packet is of the SOF packet. Frame number information incremented sequentially every frame is contained in the SOF packet 12. A frame number extraction circuit 32 provided within the receiving circuit 22 on the USB device 20 side extracts a frame number of a frame 11 at which a data transfer 13 is executed and stores it in the frame number storage register 24. When the data transfer 13 is executed, software on the USB device 20 side refers to the value stored in the frame number storage register 24 and confirms whether a difference between the value and a frame number at the time that its previous data transfer 13 has been executed, coincides with its corresponding data transfer interval (3 in an example of FIG. 2). Thus, software can sequentially determine whether the data transfer is being properly executed periodically (immediately preceding data transfer is being omitted).

The data transfer 13 comprises a token packet (transfer from the USB host 10 to the USB device 20) and a received data packet (transfer from the USB host 10 to the USB device 20) following it or a transmitted data packet (transfer from the USB device 20 to the USB host 10). Immediately after the USB device 20 has received the token packet at this time, the reception of the received data packet or the transmission of the transmit data packet is executed within the USB device 20. As shown in FIG. 1, a data extraction circuit 33 provided within the receiving circuit 22 on the USB device 20 side extracts data lying within the received data packet and stores it in the transmit/receive data storage memory 25. On the other hand, the transmitted data packet is generated by a transmitted data packet generating circuit 34 lying within the transmitting circuit 23 of the same figure from the data stored in advance in the transmit/receive data storage memory 25, and transmitted to the USB host 10 via the USB bus 30.

The USB device 20 is provided with the USB bus state value observation circuit 26. The USB bus state value observation circuit 26 has a USB reset detecting circuit 35, a bus speed determination circuit 35 and a suspend/resume detecting circuit 36. A clock stop/resume signal outputted from the suspend/resume detecting circuit 36 is inputted to the clock generator 29. The stop and start of oscillations of the clock generator 29 are controlled based on this signal in such a manner that when suspend is detected, the oscillations of the clock generator 29 are stopped and when resume is detected, the oscillations of the clock generator 29 are started.

After the detection of a USB reset signal, a high speed is determined on the USB bus 30 so that the value of the speed mode storage register 27 is decided or changed.

The data transmission/reception circuit according to the present embodiment is provided with the clock gating signal generating circuit 50 in addition to these configurations. The clock gating signal generating circuit 50 generates a clock gating signal for gating a cock signal from the clock generator 29 to the packet transmission/reception circuit 21. Thus, the clock gating signal generating circuit 50 is capable of stopping the operation of the packet transmission/reception circuit 21.

In order to decide the timing provided to turn ON the clock gating signal, a token packet received signal 51 and an SOF packet received signal 52 lying within the packet classification determination circuit 31 are supplied to the clock gating signal generating circuit 50. In order to decide the timing provided to turn OFF the clock gating signal, a speed mode signal 53 lying in the speed mode storage register 27 is supplied to the clock gating signal generating circuit 50.

Further, a USB reset detection signal 54 detected by the USB reset detecting circuit 35 and a clock stop/resume signal 55 detected by the suspend/resume detecting circuit 36 are supplied to the clock gating signal generating circuit 50 together.

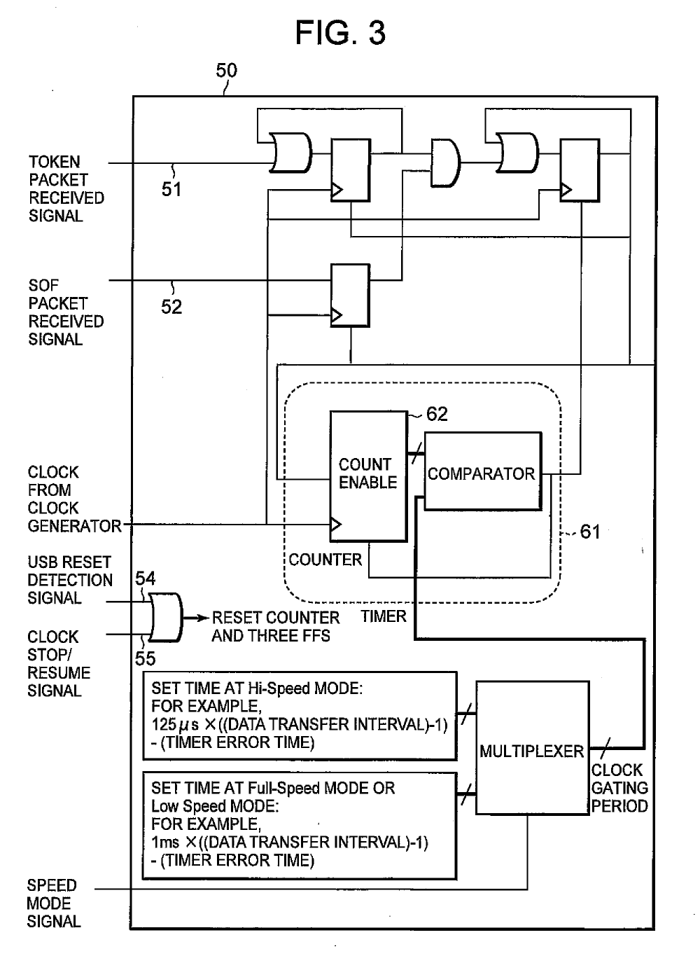

FIG. 3 shows a configuration example of the clock gating signal generating circuit 50. In reference to the token packet received signal 51 and the SOF packet received signal 52 supplied from the packet classification determination circuit 31, the clock gating signal generating circuit 50 turns ON the clock gating signal in response to the reception of an SOF packet lying immediately after the reception of a token packet in the immediately preceding frame. Consequentially, the operation of the packet transmission/reception circuit 21 is stopped. The clock gating signal is coupled to a count enable signal of a counter 62 for counting the time of a timer 61 for measuring an ON time. The timer 61 is started simultaneously when the clock gating signal is turned ON. After the timer 61 has measured a pre-set time, the clock gating signal is turned OFF.

The set time of the above timer 61 is set in the following manner, for example, according to the speed mode of data transfer by the USB device 30.

Set time at Hi-Speed mode:

125 μs×([data transfer interval]−1)−[timer error time]

Set time at Full-Speed mode or Low-Speed mode:

1 ms×([data transfer interval]−1)−[timer error time]

Here, the timer error time is set, for example, as follows;

Timer error time:

[time from the head of frame to the completion of reception of SOF packet]−[clock accuracy error]

FIG. 2 shows a time chart of the operation of the so-configured data transmission/reception circuit of the present embodiment. As shown in the same figure, a clock gating signal is turned ON at the completion time t1 of reception of an SOF packet 12 lying immediately after a data transfer 13. The clock gating signal is turned OFF at a time t2 when the time having considered a time (125 μs or 1 ms) of 1 frame and data transfer intervals (3 in the present embodiment) has elapsed.

Since no clock is supplied to the packet transmission/reception circuit 21 while the clock gating signal is ON (clock gating time 15), the reception of the SOF packet 12 is disenabled. After the turning OFF of the clock gating signal, however, a SOF packet 12 in a frame 11 at which a data transfer 13 is executed, can be received by the packet transmission/reception circuit 21.

Since the USB bus state value observation circuit 26 is supplied with a clock even while the clock gating signal is ON as shown in FIG. 1, the detection (i.e., the detection of the possibility of the data transfer speed mode of the USB bus 30 being changed) of a USB reset and the detection of suspend/resume are enabled. When the USB reset or the event of resume is detected, all FFs (flip-flops) and at least one counter lying in the clock gating signal generating circuit 50 shown in FIG. 1 are reset to turn OFF the clock gating signal.

According to the data transmission/reception circuit according to the present embodiment as described above, the clock gating signal generating circuit 50 is introduced to stop the clock supplied to the packet transmission/reception circuit 21 during the clock gating time 15 shown in FIG. 2. Thus, power savings is realized by stopping the operation of the packet transmission/reception circuit 21.

Since the SOF packet 12 of the frame 11 at which the data transfer 13 lying immediately after the end of the clock gating time 15 is executed, can be received, the function of checking for the presence or absence of a data transfer omission by a frame number lying in an SOF packet 12, based on software is maintained in a manner similar to the above-mentioned related art.

Since the clock gating signal generating circuit 50 is suitably reset even if a change of the speed mode of the data transfer of the USB bus 30 or the transition thereof to a suspend state has occurred during the clock gating time 15, its subsequent operation can be maintained.

Incidentally, the present invention is not limited to the above embodiment, but is applicable even to one changed in terms of design within the scope described in the claims of the patent.

In the case of a Low-Speed mode, for example, a keep alive signal is used as an alternative to the SOF packet without using the SOF packet in fact, and a frame number notification function is not supported. If the “SOF packet” employed in the above embodiment is substituted with the “keep alive signal” in this case, then the present invention is applicable even to a data transmission/reception circuit of a Low-Speed device.

While the preferred form of the present invention has been described, it is to be understood that modifications will be apparent to those skilled in the art without departing from the spirit of the invention. The scope of the invention is to be determined solely by the following claims.

What is claimed is:

1. A data transmission/reception circuit comprising:
transmission/reception means for performing transmission/reception of data to and from an external host device via a bus at one data transfer intervals per predetermined number of frames;
clock signal generating means for generating a clock signal and supplying the clock signal to the transmission/reception means; and
clock signal stopping means for stopping the supply of the clock signal to the transmission/reception means by the clock signal generating means during a frame free of the transmission/reception of the data by the transmission/reception means.

2. The data transmission/reception circuit according to claim 1, wherein after the transmission or reception of the data, the clock signal stopping means stops the supply of the clock signal from the completion of reception of a frame start packet transmitted from the host device by the transmission/reception means to a time prescribed based on the speed of the data transfer and the data transfer interval.

3. The data transmission/reception circuit according to claim 1, further including bus state value observing means for detecting a change of the speed of the data transfer by the bus and a resume signal for the supply of the clock signals
wherein when the change of the speed of the data transfer by the bus or the resume signal for the supply of the clock signal is detected by the bus state value observing means, the clock signal stopping means starts the supply of the clock signal to the transmission/reception means.

4. The data transmission/reception circuit according to claim 2, further including bus state value observing means for detecting a change of the speed of the data transfer by the bus and a resume signal for the supply of the clock signal,
wherein when the change of the speed of the data transfer by the bus or the resume signal for the supply of the clock signal is detected by the bus state value observing means, the clock signal stopping means starts the supply of the clock signal to the transmission/reception means.
